(19) United States
(12) Patent Application Publication
(10) Pub. No.: US 2026/0067263 A1
(43) Pub. Date: Mar. 5, 2026

(54) MODEL FOR ANALZYING AUTHENTICATION ATTEMPTS

(71) Applicant: Wells Fargo Bank, N.A., San Francisco, CA (US)

(72) Inventors: Tanya Debblay-Burrell, Fort Mill, SC (US); Marc Ward, Livermore, CA (US); Roxane S. Whalen, Battle Ground, WA (US)

(21) Appl. No.: 18/816,674

(22) Filed: Aug. 27, 2024

(51) Int. Cl. H04L 9/40

(52) U.S. Cl. CPC H04L 63/08

(57) ABSTRACT

An example computer system for analyzing authentication attempts comprises one or more processors; and non-transitory computer-readable storage media encoding instructions which, when executed by the one or more processors, causes the computer system to: receive authentication attempt data from a client device attempting to access a user account; input the authentication attempt data into a voice recognition model; receive a confidence score indicating a likelihood the audio data of the authentication attempt data matches original training data; determine whether the authentication attempt data is authenticated based on the confidence score; input the authentication attempt data into a monitor model; receive flagged authentication attempt failure data from the monitor model; input the flagged authentication attempt failure data into a failure analysis model; receive a classification for the authentication attempt data; determine a response based on the classification.

### BACKGROUND

Many systems store sensitive data about their users. Accordingly, the systems must provide sufficient security measures to ensure the user data is protected. One feature to protect user data is requiring authentication of users and user devices before granting access to the system. Some forms of authentication include passwords. Passwords ensure an account cannot be accessed without the user providing a correct string of characters. Additional authentication methods have also been developed, such as voice authentication.

A voice authentication attempt can fail for many reasons. In some examples, a user that does is not the user that provided the original audio input may be attempting to access the systems. The systems may detect differences in voice and determine that another user is attempting to fraudulently access the user account. In some examples, the voice authentication systems provide a false negative (i.e., the system denies access to the user who provided the original audio input).

### SUMMARY

Examples provided herein are directed to analyzing authentication attempts.

According to one aspect, an example computer system for analyzing authentication attempts comprises one or more processors; and non-transitory computer-readable storage media encoding instructions which, when executed by the one or more processors, causes the computer system to: receive authentication attempt data from a client device attempting to access a user account, the authentication attempt data including audio data; input the authentication attempt data into a voice recognition model; receive a confidence score indicating a likelihood the audio data of the authentication attempt data matches original training data; determine whether the authentication attempt data is authenticated based on the confidence score; responsive to the authentication attempt data failing to authenticate, input the authentication attempt data into a monitor model; receive flagged authentication attempt failure data from the monitor model; input the flagged authentication attempt failure data into a failure analysis model, wherein the failure analysis model is configured to classify the flagged authentication attempt failure data into classifications that indicate a reason the authentication attempt data failed; receive a classification for the authentication attempt data; determine a response based on the classification.

According to another aspect, an example method for analyzing authentication attempts comprises receiving authentication attempt data from a client device attempting to access a user account, the authentication attempt data including audio data; input the authentication attempt data into a voice recognition model; receive a confidence score indicating a likelihood the audio data of the authentication attempt data matches original training data; determining whether the authentication attempt data is authenticated based on the confidence score; responsive to the authentication attempt data failing to authenticate, inputting the authentication attempt data into a monitor model; receiving flagged authentication attempt failure data from the monitor model; inputting the flagged authentication attempt failure data into a failure analysis model, wherein the failure analysis model is configured to classify the flagged authentication attempt failure data into classifications that indicate a reason for the authentication attempt data failed; receiving a classification for the authentication attempt data; determining a response based on the classification.

According to an additional aspect, an example non-transitory computer readable medium has instructions stored thereon, the instructions causing one or more processors to perform: receiving authentication attempt data from a client device attempting to access a user account; input the authentication attempt data into an authentication model; receive a confidence score indicating a likelihood the authentication attempt data matches original training data; determining whether the authentication attempt data is authenticated based on the confidence score; responsive to the authentication attempt data failing to authenticate, inputting the authentication attempt data into a monitor model; receiving flagged authentication attempt failure data from the monitor model; inputting the flagged authentication attempt failure data into a failure analysis model, wherein the failure analysis model is configured to classify the flagged authentication attempt failure data into classifications that indicate a reason the authentication attempt data failed; receiving a classification for the authentication attempt data; and determining a response based on the classification.

### DESCRIPTION OF THE DRAWINGS

FIG. 1 shows an example system for analyzing authentication attempts by client devices.

FIG. 2 shows example logical components of a server device of the system of FIG. 1.

FIG. 3 shows example logical components of a client device of the system of FIG. 1.

FIG. 4 shows a flow diagram of an example data flow for voice authentication using the server device of FIG. 2.

FIG. 5 shows an example method for analyzing voice authentication attempts.

FIG. 6 shows example physical components of the server device of FIG. 2.

### DETAILED DESCRIPTION

This disclosure relates to analyzing authentication attempts. Many different types of entities require a user to authenticate themselves before accessing their systems. In addition, for access, a user's credentials may expire after a certain amount of time, thus, the systems may require reauthentication for access. In addition, systems may require frequent authentication to ensure the integrity of their user bases. As can be seen, systems may require a user to authenticate themselves for a variety of reasons.

In addition, a system may require a user to reauthenticate themselves after a predetermined period to engage a user in a network and prevent multiple accounts being operated by a single person. For example, the system may be a social network and seek to increase the quality of the social network by limiting the number of accounts per user to one and not allow users to use other accounts. To accomplish this goal, the system can require or incentivize users to authenticate themselves to refresh their accounts. Further, the system uses voice authentication or biometric authentication to prevent users from sharing their passwords in some embodiments. Once a predetermined period of time has passed, the system requests the users to reauthenticate their account.

In some embodiments, the authentication attempts may be in a form that requires enhanced analysis to validate, such as using voice audio recognition. To reduce the need for a human operator for the enhanced analysis, the system uses an authentication model to validate the authentication attempt. For example, the authentication model may be a voice recognition model that is trained to recognize a voice of a user. That is, the voice recognition model can match audio input of the user to previously recorded audio data provided by the user. Once verified, the system grants access to the user account to the requesting entity or device. If the authentication model generates a confidence score that is too low, then the system denies access to the user account.

The system also includes a monitor model to monitor authentication attempts. As authentication failures are detected, the monitor model raises red flags to indicate potentially fraudulent activity. If the number of authentication attempt failures exceeds a threshold of concern, then the monitor model may provide the indicator. The threshold can be influenced by a number of factors, such as number of attempts, frequency of attempts, location of an attempting device, confidence score of authentication attempts, and others. The monitor model also produces failure data associated with each authentication attempt for each user account.

The system also includes a failure analysis model to perform post-analysis of the of the failure data. On account of the many reasons for failure, determining the causes or reasons an authentication attempt failed provides useful insights. For example, the failure may be because the authentication model incorrectly determined that the provided audio input does not match the previously recorded audio data. This result can frustrate a user that provided the original audio. Thus, post failure analysis may reveal that the original audio was provided over a poor connection that resulted in a poor audio sample. Further attempts are then difficult for the authentication model to match with the original audio due to the poor circumstances related to capturing the original audio. The failure analysis can determine this circumstance, such as a poor connection, is the reason for the failures through classification of the failure data.

These determined reasons are often determined manually by user review. However, performing this analysis at scale is difficult on account of the amount of data that must be reviewed. The failure analysis model is configured to perform this analysis on large amounts of data and automatically provide classifications for the authentication attempt failures for each user account, which improves the user experience.

Once a cause for the authentication failure has been determined, the system can determine an appropriate action. In line with the previous example, the system can send a request to the user to provide new audio input to retrain the authentication model, thus, improving the user experience. In another example, if the failure authentication attempt is determined to be due to fraud, the system can lock-down the user account. Other actions can be taken to respond to other determined failure causes.

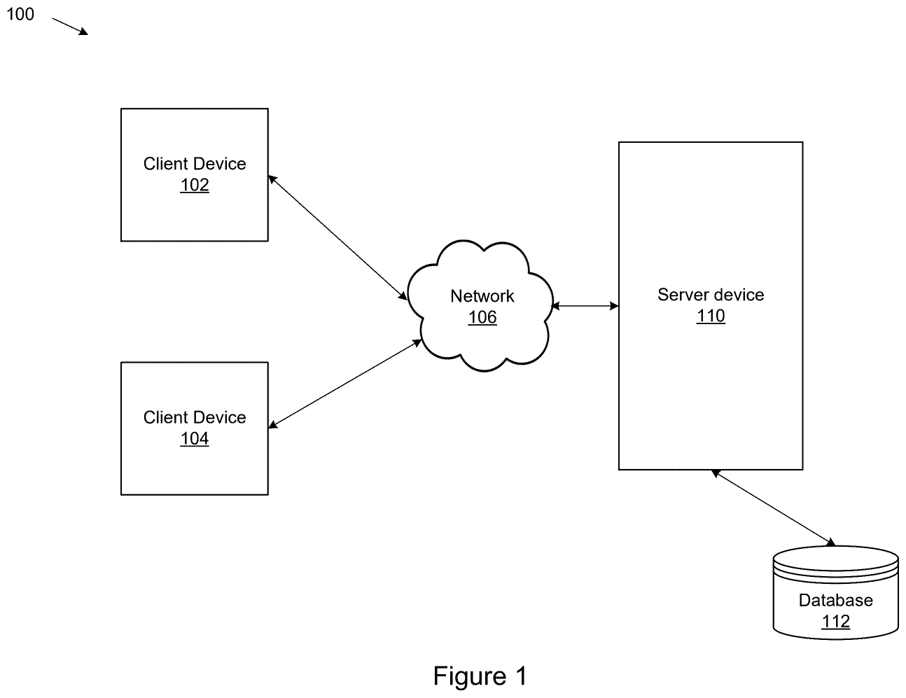

FIG. 1 schematically shows an example system 100 for analyzing authentication attempts by client devices. In the shown embodiment, the system 100 includes a client device 102 and a client device 104 that connect through a network 106 to a server device 110. The server device 110 also connects to a database 112.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 110 is owned by a financial institution, such as a bank. The client device 102 and the client device 104 can be programmed to communicate with the server device 110 to perform various tasks, such as financial transactions. Many other configurations are possible, and the disclosure is not limitation to the financial industry.

In addition, the server device 110 is configured to provide functionality related to authenticating requests, monitoring the requests for failure data and fraudulent activity, and analyzing the failure data. Each of the client device 102 and the client device 104 are configured to request access to the system and associated user accounts. In some embodiments, the user accounts are associated with the client device 102 or the client device 104. The server device 110 then requests authentication from the requesting devices, which may be the client device 102.

The client device 102 then performs an authentication attempt. The authentication attempt may include providing an audio input sample to the server device 110. The audio input sample may be audio data representing the user's spoken word or phrase into an audio capturing component, such as a microphone.

Once the server device 110 receives the authentication attempt, the server device 110 authenticates the request. For example, the server device 110 may use a voice recognition model to analyze the request and determine if the received audio input sample matches a trained version of the correct user's voice. Responsive to authenticating the request, the server device 110 grants access for the user account to the client device 102. However, the server device 110 is also configured to deny access if the server device 110 fails to authenticate the request. For example, the server device 110 may fail to generate a high enough confidence score representing similarity for the received audio input sample when compared to the original audio stored for the original user.

In addition, the server device 110 may monitor the failed authentication attempts of the user account. As more authentication attempts are recorded for the user account, the server device 110 may provide an alert or notification to indicate potential fraud. In some embodiments, the server device 110 considers multiple factors related to the authentication requests and associated context of the user account when determining whether to provide the alert related to fraud. Further, the server device generates failure data related to each authentication attempt that failed.

The server device 110 also analyzes the failure data to classify each authentication failure. The classifications may indicate reasons for why an authentication attempt failed to validate. For example, a classification may indicate the original audio used to authenticate received audio samples was of poor quality. Thus, the server device 110 can provide a request to provide new audio data to train the voice recognition model. Other classifications can be used as well to provide additional analysis as to the reason for a particular authentication attempt failure.

The server device 110 may also be configured to host a transaction network, which the server device 110 uses the authentication functions to authenticate user accounts registered with the transaction network. In some embodiments, the transaction network is a social network where individual user accounts can share information or conversations among one another. The transactional network may use the disclosed authentication processes for disclosing or redisclosing user accounts to affirm that each user account has a properly identified user. Accurately identifying users enables additional functions such as ensuring contracts are properly executed in a transaction or determining an accurate number of users on the social network. These benefits lead to a higher quality network of connected user accounts.

To encourage self-disclosure through re-authenticating their accounts, the server device 110 can provide incentives to user accounts. In some embodiments, incentives can include increasing a user account's status. As the user account increases in status, the user account can be rewarded benefits such as money (e.g., cryptocurrency), points, or other valuable perks. In some embodiments, the server device 110 provides these rewards to a user account for successfully authenticating their account.

In some embodiments, models related to biometric scans (e.g., face scan or finger-print scan) may be used for the same purpose. For example, the server device 110 may use models trained on biometric data to complete the same functions of authenticating, monitoring, and analyzing authentication failure data.

The example client devices 102, 104 can be used by customers and/or team members of the financial institution to perform various tasks. For instance, a team member of the financial institution can use the client device 102 to perform tasks such as access financial settings and documents, transaction accounts, etc. Similarly, a customer of the financial institution can use the client device 104 to perform such tasks.

In addition, the client device 102 and the client device 104 are configured to receive input for an authentication attempt. In some embodiments, the input is the audio input sample. Further, the client device 102 and the client device 104 can receive text input that is a password to further authenticate the requesting user. In some embodiments, the client device 102 and the client device 104 are configured to access the transaction network of the server device 110 and provide features related to associated user accounts registered on the transaction network.

The client device 102 and the client device 104 may include components for capturing input. In some embodiments, the client device 102 and the client device 104 includes a microphone for receiving audio input and a keyboard or touch screen for receiving text input. In other embodiments, the client device 102 and the client device 104 include a display for showing different aspects related to authenticating and accessing the transaction network.

The database 112 stores data used within the system 100. In some embodiments, the database maintains a user account repository for the user accounts registered to the transaction network. The user accounts may include associated statuses. The statuses may be in the form of different tiers. In some embodiments, the database 112 stores authentication failure data. The authentication failure data is data that corresponds to authentication attempts that failed to validate.

In some embodiments, the database 112 maintains or hosts a data repository for failure classifications. The failure classifications indicate different types or reasons for why an authentication attempt failed. In some embodiments, the database is a relational database or a non-relational database. Further, the database may be remotely connected to the server device 110 through the network 106 in some embodiments.

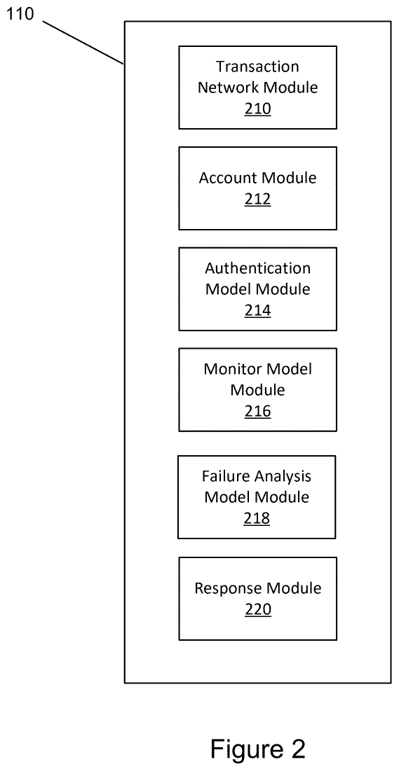

FIG. 2 shows example logical components of the server device 110 of the system 100. In the shown embodiment, the server device 110 includes a transaction network module 210, an account module 212, an authentication model module 214, a monitor model module 216, a failure analysis model module 218, and a response module 220.

The transaction network module 210 manages the transaction network. Functions of the transaction network module 210 include registering user accounts, maintaining the back-end services of an application that implements the transaction network, and connecting to the client device 102 and the client device 104 to provide access and use of the transaction network module 210 to associated users. In some embodiments, the transaction network module 210 also manages the statuses of each associated user accounts. For example, the transaction network module 210 can increase or decrease a status of a user account. The user account may increase in status or be provided rewards based on the user account being authenticated.

In some embodiments, the transaction network module 210 provides perks or rewards to the user account based on the status. The transaction network module 210 may add points to the user account based on the user authenticating their account. In some embodiments, the transaction network module 210 adds points to a user account based on the user account interacting with the transaction network module 210 such as completing a transaction or interacting with another user account. The transaction network module 210 also can lower statuses, remove user accounts, or lock down user accounts based on detected fraudulent activity.

The account module 212 manages login attempts and authentication requests from the client device 102 and the client device 104. The account module 212 also requests authentication from the client device 102 and the client device 104. Once the client device 102 attempts to access the transaction network module 210, the account module 212 provides a prompt to the client device 102 requesting input as an authentication attempt. The input may be an audio input sample. Once the account module 212 receives the authentication attempt including the audio input sample from the client device 102, the account module 212 provides the audio input sample to the authentication model module 214.

In some embodiments, the account module 212 receives indicators from the authentication model module 214 that show whether the authentication attempt is valid. Responsive to the authentication attempt being valid, the account module 212 grants access to the transaction network module 210 for the client device 102. Responsive to the authentication attempt being invalid, the account module 212 denies access to the transaction network module 210 for the client device 102. In some embodiments, the account module 212 may send a request to the client device 102 requesting the user to attempt authentication again.

Once an authentication attempt has failed, the account module 212 is configured to send authentication attempt failures to the monitor model module 216. The authentication attempt failures are sent in the form of data that is monitored to determine if the number of failures exceeds a threshold. In some embodiments, the account module 212 may receive an indicator from the monitor model module 216 that flags an account as exceeding the threshold for failure attempts. The account module 212 may then lock down the user account for which the authentication attempts were trying to gain access.

The authentication model module 214 validates received authentication attempts. For example, the authentication model module 214 may be a voice recognition model that receives the audio input sample as input. Prior to receiving an authentication attempt, the authentication model module 214 is trained on voice data from the correct user. Then, the authentication model module 214 determines if the received audio input sample sufficiently matches the training data. In some embodiments, determining whether the received audio input sample sufficiently matches the training data includes generating a confidence score that represents how close the audio input sample matches the training data.

Once the authentication attempt is determined to be valid, the authentication model module 214 indicates to the account module 212 that the authentication attempt has been validated. The account module 212 then grants access to the client device 102. If the authentication attempt is determined to be invalid, the authentication model module 214 indicates to the account module 212 that the authentication attempt is invalid. The account module 212 then denies access to the client device 102.

As described previously, the authentication model module 214 may use a voice authentication model in some embodiments. Voice authentication models, also known as voice biometrics or speaker recognition, are a technology that uses a person's unique vocal characteristics to verify their identity. It analyzes various features of an individual's voice, such as pitch, tone, cadence, and pronunciation, to create a voiceprint that serves as a unique identifier.

In some embodiments, the voice authentication model is a text dependent model. Text dependent models include having the user speak a specific pre-determined phrase or passphrase during both enrollment and authentication. The system compares the spoken phrase with the stored voiceprint to verify the user's identity. In some embodiments, the voice authentication model is text-independent model. This type of model does not rely on specific phrases. Instead, it analyzes the user's natural speech patterns during a conversation or interaction to verify their identity.

The monitor model module 216 monitors authentication failure attempts associated with the user account to determine if the authentication failure attempts exceed a threshold using a stored machine learning model. In some embodiments, the authentication failure attempts exceed the threshold if a number or percentage of authentication attempts fail. Exceeding the threshold may indicate that another individual is attempting to gain unauthorized access into the user account. In some embodiments, the monitor model module 216 determines the authentication attempt failures exceeds the threshold when the number of authentication attempt failures exceeds a predetermined number.

In some embodiments, the monitor model module 216 may consider additional context of the authentication attempt failures. For example, the monitor model module 216 may consider the period of time since the last successful authentication, the frequency of authentication failure attempts, the recency of receiving training data for the user account, metadata/header data of the attempts, and/or the success rate of the attempts. In some embodiments, the metadata/header data includes a requesting device (i.e., the client device 102), location of the requesting device, login history of the requesting device, and other metadata.

In some embodiments, the monitor model module 216 is configured to flag user accounts associated with the authentication attempt failures based on business judgement rules. For example, a success rate for authentication attempts for a user account that falls below seventy-five percent may trigger the monitor model module 216 to flag the account for further analysis or potentially fraudulent activity.

The monitor model module 216 includes the stored machine learning model that is trained on audio input samples and training data. Further, user account data associated with the authentication attempt failures is also used for training, such as the number of attempts, the recency of attempts, recency the training data was obtained, and other header data. The monitor model module 216 may be trained for risk reduction of fraudulent activity. In some embodiments, the monitor model module 216 uses strict business judgment.

The stored machine learning model of the monitor model module 216 may be a qualitative model that analyzes relationships of the authentication attempt failure data as described above. In some embodiments the monitor model module 216 also produces failure data that includes the flagged authentication attempt failures. The failure data may include other authentication attempt failures. The failure data may be provided to the account module 212 for storage or transmission to another component. In some embodiments, the failure data is transferred from the monitor model module 216 to the failure analysis model module 218 for further analysis.

The failure analysis model module 218 includes a machine learning model for analyzing the failure data. The failure analysis model module 218 runs post-analysis of the authentication attempt failures to identify significant errors between predicted outputs of the authentication model module 214 and the actual outputs. In some embodiments, the failure analysis model module 218 identifies errors. The errors may include a predicted output differing from the actual output by an amount that exceeds a predetermined threshold. In some embodiments, the failure analysis model module 218 classifies the authentication attempt failures into different classification categories. The classification categories can be stored as a plurality of classification categories in the database 112.

In one example, one classification category may indicate that a male voice was attempting to login into an account that is associated with a female. The classification category may also consider that the user account has a spouse, thus, the classification category indicates that there is a strong probability that the spouse is attempting to login to the user account for the user.

In some embodiments, the classification category indicates that the audio sample input is of a much younger voice than the user associated with the user account that had an attempted login. Accordingly, the system may classify the authentication attempt failure as potential elder fraud. In some embodiments, the classification category indicates a poor training data sample. For example, the original audio input has low quality, which causes the model to authenticate incorrectly. Many other classifications can be included as well.

In some embodiments the failure analysis model module 218 classifies the authentication attempt failures based on a determined likelihood score that the selected classification category indicates the reason the authentication attempt failed. For example, the failure analysis model module 218 may determine an authentication attempt failure has an eighty percent chance that is failed due to poor training data.

Continuing the previous example, the user may have recorded their voice over a poor connection. Accordingly, the captured audio data is of poor quality and does not accurately represent the user's voice. Future voice authentications then incorrectly fail because the model has poor training data. The failure analysis model module 218 determines the poor training data is why the authentication attempt failed.

In some embodiments, the parameters of the failure analysis model module 218 can be adjusted. For example, the failure analysis model module 218 identifies an incorrect classification for an authentication attempt. The failure analysis model module 218 can receive input or adjustment to its parameters so that it produces the correct classification. In some embodiments, the failure analysis model module 218 is retrained on new data to adjust the output.

In some embodiments, the failure analysis model module 218 includes a nonlinear autoregressive neural network (NARNN) model. A NARNN model is a type of artificial neural network specifically designed for time series forecasting. It leverages the principles of autoregression, where the current value of a variable is predicted based on its own past values, and the nonlinear modeling capabilities of neural networks.

NARNN models use past values of the time series as input to predict future values. The number of past values considered is determined by the “lag” or “delay” parameter of the model. NARNN models employ nonlinear activation functions within the network layers, enabling them to capture complex relationships and patterns in the time series data. NARNN models typically consist of an input layer, one or more hidden layers, and an output layer. The input layer receives the lagged time series values, the hidden layers process the information through nonlinear transformations, and the output layer produces the predicted future value.

In some embodiments, the stored model of the failure analysis model module 218 is trained on the voice audio data used to train the authentication model module 214. In some embodiments, the failure analysis model module 218 receives additional authentication data (e.g., audio data from additional users) or other training data to learn and train. In some embodiments, the failure analysis model module 218 can be manually adjusted based on additional parameters.

The response module 220 determines a response for each authentication attempt failure based on its failure classification. For example, if the authentication attempt failure was classified for elder fraud, the response module 220 will notify respective entities for further investigation into the account. In some embodiments, the response module 220 locks the account and notifies the client device 102 the account is locked until the user goes to a physical location to verify their identity.

In some embodiments, the response module 220 may send a request to the client device 102 requesting the user provide additional training data if the previous authentication attempt failure was classified as a failure due to poor training data. In some embodiments, the authentication attempt failures are categorized based on the fact that an extended period of time between authentication attempts has occurred. The response module 220 may request additional verification from the client device 102. In some embodiments, the response module 220 can notify entities to perform a wellness check.

For example, if the user account has other associated user accounts, such as friends, the response module 220 can request one of the friend user accounts to assist with verifying the identity of the individual trying to gain access to the user account. For example, the response module 220 may send a request for assistance to client device 104, which is logged into a friend account associated with the user account for which extra verification is sought.

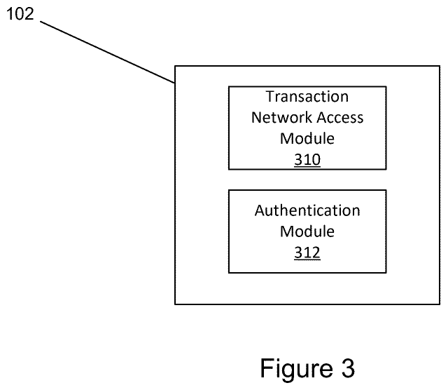

FIG. 3 shows example logical components of the client device 102 of the system 100. In this embodiment, the client device 102 includes a transaction network access module 310 and an authentication module 312. In some embodiments, the client device 104 includes the same or similar components.

The transaction network access module 310 provides access of the transaction network to the client device 102. Further, the transaction network access module 310 connects to the transaction network module 210. The transaction network access module 310 exchanges data with the transaction network module 210, such as data to cause the client device 102 to display a graphical user interface (GUI) for the user to interact and input data that is sent back to the transaction network module 210.

For example, the transaction network access module 310 can receive inputs from the user that result in data being sent to the transaction network module 210 that changes settings of the user account, enters a transaction, or other commands and features the user is interested in completing on the transaction network.

The authentication module 312 receives input to authenticate the user of the client device 102 in order to grant access to the user account. In addition, the authentication module 312 connects to the account module 212 to authenticate the identity of the user.

In some embodiments, the authentication module 312 receives input for an authentication attempt. For example, the input may be audio input. The user may speak a phrase or specific word. Then, the authentication module 312 sends the input to the account module 212. The account module performs previously discussed features to determine if the authentication fails or succeeded.

The authentication module 312 also receives a message indicating that access was granted. The transaction network access module 310 is then able to access the transaction network and utilize all associated features of the transaction network. In some embodiments, the authentication module 312 receives a request from the account module 212 to the user that requests the user attempt login again.

The user may need to speak the passphrase or password again, which is captured by the authentication module 312 and sent to the account module 212 for authentication. If the authentication module 312 receives a message indicating that the user could not be authenticated based on the input, then the transaction network access module 310 is not able to access the transaction network module 210 and the user account registered with the transaction network module 210.

In some embodiments, the client device 102 includes some or all of the shown logical components of the server device 110. For example, the client device may include the transaction network module 210, the account module 212, the authentication model module 214, the monitor model module 216, the failure analysis model module 218, or the response module 220. In some embodiments, the client device 102 performs some or all of the described associated functions.

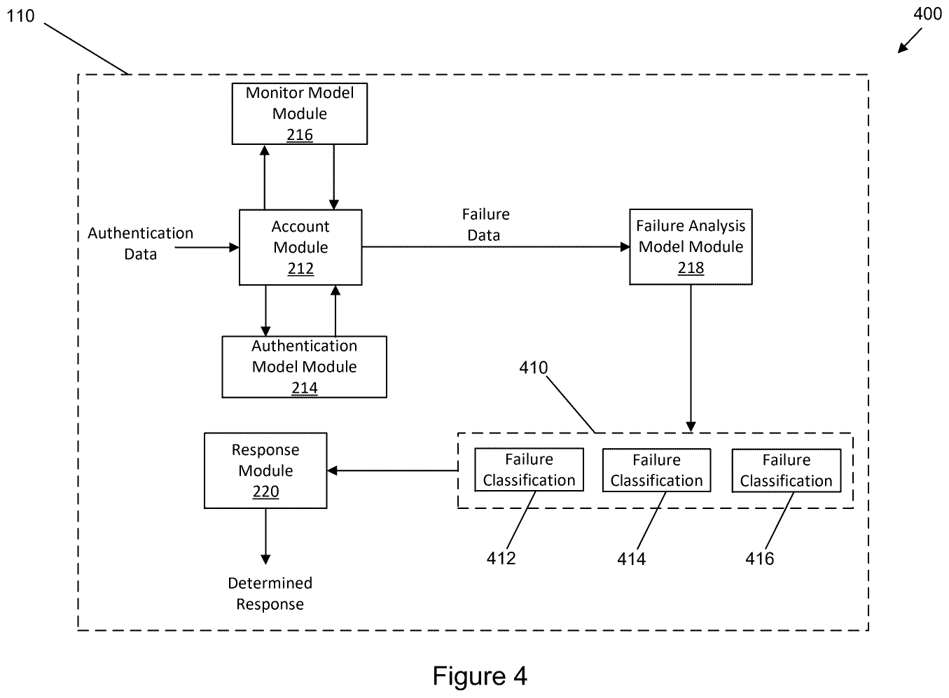

FIG. 4 shows an example data flow diagram 400 for voice authentication using the server device 110. In this embodiment, the account module 212 receives authentication data. The authentication data may be received from the transaction network module 210 of the server device 110 or the authentication module 312 of the client device 102. Once the account module 212 receives the authentication data, the account module 212 calls the authentication model module 214 to evaluate the authentication attempt. The authentication model module 214 then inputs the received authentication data into the model and determines if the authentication data sufficiently matches the training data.

If the authentication attempt fails, the monitor model module 216 is called to monitor if the authentication attempt failures exceed the threshold. The monitor model module 216 flags authentication attempt failures that raise concerns. For example, if the monitor model module 216 detects a high frequency of authentication attempt failures for a single user account, the monitor model module 216 may flag the authentication attempt failures or the user account.

The account module 212 can take appropriate action such as locking the user account. The monitor model module 216 may also generate failure data that includes the flagged authentication failure data and other authentication failure data. The failure data is provided to the account module 212 for storage and further transfer. The account module 212 then provides the failure data to the failure analysis model module 218.

The failure analysis model module 218 analyzes the failure data. As previously discussed, the failure analysis model module 218 classifies each authentication attempt failure into a classification of a plurality of failure classifications 410. The plurality of failure classifications 410 includes a failure classification 412, a failure classification 414, and a failure classification 416. In some embodiments, the plurality of failure classifications includes additional classifications not shown.

In some embodiments, the failure classifications include a classification for potential fraud, a classification for a spouse logging into for a user account, and a classification for poor training data. The classifications can be for additional failure reasons as well.

The failure classifications are then used by the response module to determine appropriate responses. For example, the response module 220 may notify a local entity to monitor a user account for potential fraud. If the entity is a bank, the bank may require additional verification in person, such as requiring a license, before allowing access to an account. The response module 220 can output many different responses depending on the selected failure classification of the plurality of failure classifications 410.

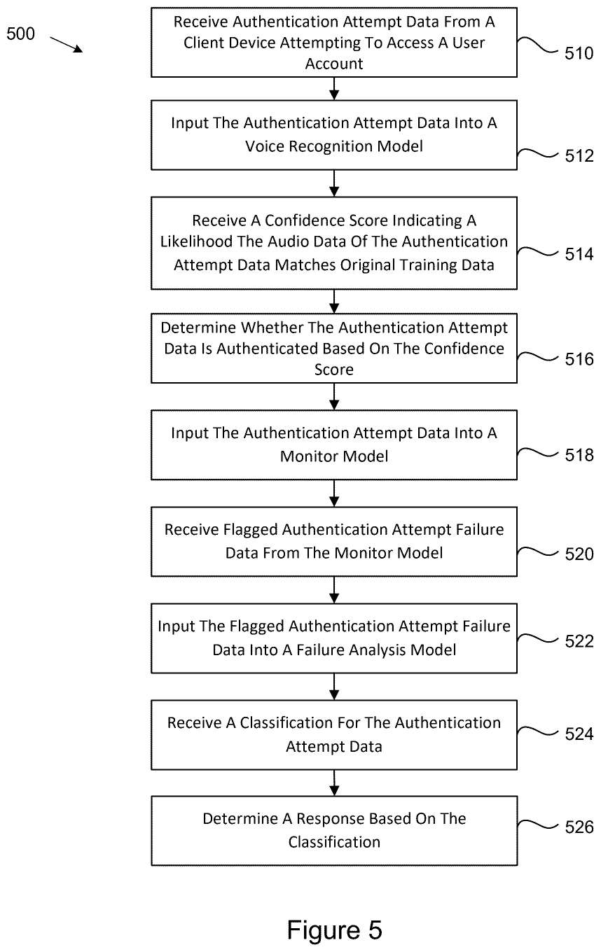

FIG. 5 shows an example method 500 for analyzing voice authentication attempts. In this embodiment, the method 500 includes an operation 510, an operation 512, an operation 514, an operation 516, an operation 518, an operation 520, an operation 522, an operation 524, and an operation 526. Some or all of the discussed operations may be performed by a single or multiple discussed systems and devices. For example, the server device 110 may perform the method 500.

At operation 510, authentication attempt data is received from a client device attempting to access a user account. In some embodiments, the server device 110 receives the authentication attempt data from the client device 102. Further, the authentication attempt data may include audio data or biometric data. In some embodiments, the user account is registered with the transaction network module 210. In some embodiments, the authentication attempt data was received in response to sending a request for authentication of the user account.

At operation 512, the authentication attempt data is input into a voice recognition model. In some embodiments, the authentication attempt data is input into the authentication model module 214. The authentication model module 214 then validates the authentication attempt data. For example, audio data of the authentication attempt data may be input into the model, analyzed by the model, which includes comparing to past training data, then outputting a confidence score indicating a likelihood that the authentication attempt data matches the previous training data.

At operation 514, a confidence score indicating a likelihood the audio data of the authentication attempt data matches original training voice data is received. In some embodiments, the authentication model module 214 provides the confidence score. Further, the authentication model module 214 analyzes the authentication attempt data to compare to past training data to produce the confidence score.

At operation 516, whether the authentication attempt data is authenticated based on the confidence score is determined. In some embodiments, the confidence score is compared to a threshold. If the confidence score is below the threshold, then the authentication attempt data fails to validate. If the confidence score is above the threshold, then the authentication attempt data successfully validates.

At operation 518, the authentication attempt data is input into a monitor model. In some embodiments, the authentication attempt data is input responsive to the authentication attempt data failing to authenticate by the authentication model module 214 or a voice recognition model. In some embodiments, the monitor model module 216 receives the authentication attempt data. Further the monitor model module 216 receives additional authentication data. The additional authentication data may include all past authentication attempts and associated data.

The monitor model module 216 then analyzes the authentication attempt data and the additional authentication data to determine whether to flag the user account and/or the authentication attempt data. In some embodiments, the monitor model module 216 is configured to determine whether authentication attempt failures associated with the user account exceed a monitor threshold.

In some embodiments, the monitor model module 216 may determine a frequency of authentication failure attempts, a recency of receiving training data for the user account, a period of time since a last successful authentication, or metadata data of the attempts. These aspects may then be used to flag the user account. For example, if the authentication attempt data and the additional authentication data indicates three unsuccessful attempts, then the user account is flagged for fraudulent activity and may require additional authentication.

At operation 520, flagged authentication attempt failure data is received from the monitor model. In some embodiments, the flagged authentication attempt failure data includes a user account that has a large number of associated authentication attempts that failed. In some embodiments, the monitor model module 216 flags the authentication attempt data and/or the user accounts to generate the flagged authentication attempt failure data.

At operation 522, the flagged authentication attempt failure data is input into a failure analysis model. In some embodiments, the failure analysis model module 218 receives the authentication attempt failure data and performs an analysis. The failure analysis model module 218 then classifies the authentication attempt failure data to produce a classification. In some embodiments, the failure analysis model module 218 is configured to classify the flagged authentication attempt failure data into classifications that indicate a reason for the authentication attempt data failure.

In some embodiments, the failure analysis model module 218 identifies an error. The error may include a predicted output differing from an actual output by an amount that exceeds a predetermined threshold. In some embodiments, the failure analysis model module 218 determines a likelihood score of the classification indicating the reason for the authentication attempt data failure.

At operation 524, a classification for the authentication attempt data is received. In some embodiments, the classification is a fraudulent authentication attempt or a poor training data sample. In some embodiments, the failure analysis model module 218 provides the classification to the response module 220.

At operation 526, a response based on the classification is determined. In some embodiments, the response module 220 determines the response. The response may be response is to contact a local bank to require additional authentication or to request additional audio training data.

In some embodiments, the method 500 may further include providing access to the user account response to the authentication attempt data successfully authenticating. In some embodiments, the method 500 may further include providing rewards to the user account responsive to the successful authentication.

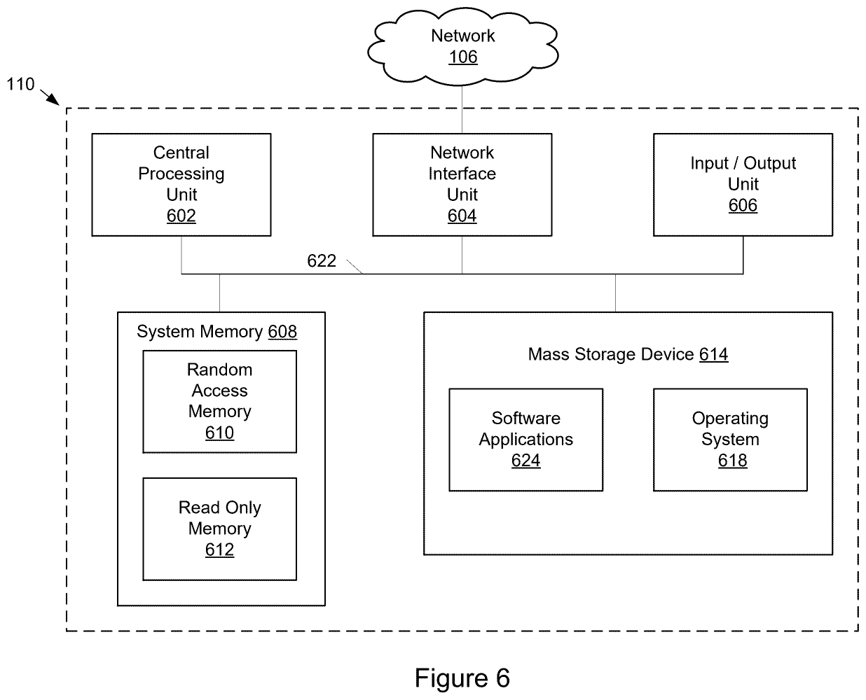

As illustrated in the embodiment of FIG. 6, the example server device 110, which provides the functionality described herein, can include at least one central processing unit (“CPU”) 602, a system memory 608, and a system bus 622 that couples the system memory 608 to the CPU 602. The system memory 608 includes a random-access memory (“RAM”) 610 and a read-only memory (“ROM”) 612. A basic input/output system containing the basic routines that help transfer information between elements within the server device 110, such as during startup, is stored in the ROM 612. The server device 110 further includes a mass storage device 614. The mass storage device 614 can store software instructions and data. A central processing unit, system memory, and mass storage device similar to that shown can also be included in the other computing devices disclosed herein.

The mass storage device 614 is connected to the CPU 602 through a mass storage controller (not shown) connected to the system bus 622. The mass storage device 614 and its associated computer-readable data storage media provide non-volatile, non-transitory storage for the server device 110. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 110.

According to various embodiments of the invention, the server device 110 may operate in a networked environment using logical connections to remote network devices through network 106, such as a wireless network, the Internet, or another type of network. The server device 110 may connect to network 106 through a network interface unit 604 connected to the system bus 622. It should be appreciated that the network interface unit 604 may also be utilized to connect to other types of networks and remote computing systems. The server device 110 also includes an input/output controller 606 for receiving and processing input from a number of other devices, including a touch user interface display screen or another type of input device. Similarly, the input/output controller 606 may provide output to a touch user interface display screen or other output devices.

As mentioned briefly above, the mass storage device 614 and the RAM 610 of the server device 110 can store software instructions and data. The software instructions include an operating system 618 suitable for controlling the operation of the server device 110. The mass storage device 614 and/or the RAM 610 also store software instructions and applications 624, that when executed by the CPU 602, cause the server device 110 to provide the functionality of the server device 110 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for analyzing authentication attempts, the computer system comprising:
one or more processors; and
non-transitory computer-readable storage media encoding instructions which, when executed by the one or more processors, causes the computer system to:
receive authentication attempt data from a client device attempting to access a user account, the authentication attempt data including audio data;
input the authentication attempt data into a voice recognition model;
receive a confidence score indicating a likelihood the audio data of the authentication attempt data matches original training data;
determine whether the authentication attempt data is authenticated based on the confidence score;
responsive to the authentication attempt data failing to authenticate, input the authentication attempt data into a monitor model;
receive flagged authentication attempt failure data from the monitor model;
input the flagged authentication attempt failure data into a failure analysis model, wherein the failure analysis model is configured to classify the flagged authentication attempt failure data into classifications that indicate a reason the authentication attempt data failed;
receive a classification for the authentication attempt data;
determine a response based on the classification.

2. The computer system of claim 1, wherein the failure analysis model is configured to identify an error, the error including a predicted output differing from an actual output by an amount that exceeds a predetermined threshold.

3. The computer system of claim 1, wherein the response is to contact a local bank to require additional authentication.

4. The computer system of claim 1, wherein the response is to request additional audio training data.

5. The computer system of claim 1, wherein the failure analysis model determines a likelihood score of the classification indicating the reason the authentication attempt data failed.

6. The computer system of claim 1, wherein the failure analysis model is a nonlinear autoregressive neural network model.

7. The computer system of claim 1, wherein the monitor model is configured to:
determine whether authentication attempt failures associated with the user account exceed a monitor threshold; and
determine a frequency of authentication failure attempts, a recency of receiving training data for the user account, a period of time since a last successful authentication, or metadata data of the attempts.

8. The computer system of claim 1, wherein the classification is a fraudulent authentication attempt or a poor training data sample.

9. The computer system of claim 1, wherein the computer system is further caused to:
responsive to the authentication attempt data successfully authenticating, provide access to the user account, wherein the user account is registered on a transaction network.

10. The computer system of claim 9, wherein the computer system is further caused to:
provide rewards to the user account.

11. A method for analyzing authentication attempts, the method comprising:
receiving authentication attempt data from a client device attempting to access a user account, the authentication attempt data including audio data;
input the authentication attempt data into a voice recognition model;
receive a confidence score indicating a likelihood the audio data of the authentication attempt data matches original training data;
determining whether the authentication attempt data is authenticated based on the confidence score;
responsive to the authentication attempt data failing to authenticate, inputting the authentication attempt data into a monitor model;
receiving flagged authentication attempt failure data from the monitor model;
inputting the flagged authentication attempt failure data into a failure analysis model, wherein the failure analysis model is configured to classify the flagged authentication attempt failure data into classifications that indicate a reason for the authentication attempt data failed;
receiving a classification for the authentication attempt data;
determining a response based on the classification.

12. The method of claim 11, wherein the failure analysis model performs identifying an error, the error including a predicted output differing from an actual output by an amount that exceeds a predetermined threshold.

13. The method of claim 11, wherein the response is to contact a local bank to require additional authentication.

14. The method of claim 11, wherein the response is to request additional audio training data.

15. The method of claim 11, wherein the failure analysis model performs determining a likelihood score of the classification indicating the reason the authentication attempt data failed.

16. The method of claim 11, wherein the failure analysis model is a nonlinear autoregressive neural network model.

17. The method of claim 11, wherein the monitor model is configured to perform:
determining whether authentication attempt failures associated with the user account exceed a monitor threshold;
determining a frequency of authentication failure attempts, a recency of receiving training data for the user account, a period of time since a last successful authentication, or metadata data of the authentication attempt data.

18. The method of claim 11, wherein the classification is a fraudulent authentication attempt or a poor training data sample.

19. The method of claim 11, further comprising:
responsive to the authentication attempt data successfully authenticating, provide access to the user account, wherein the user account is registered on a transaction network.

20. A non-transitory computer readable medium having instructions stored thereon, the instructions causing one or more processors to perform:
receiving authentication attempt data from a client device attempting to access a user account;
input the authentication attempt data into an authentication model;
receive a confidence score indicating a likelihood the authentication attempt data matches original training data;
determining whether the authentication attempt data is authenticated based on the confidence score;
responsive to the authentication attempt data failing to authenticate, inputting the authentication attempt data into a monitor model;
receiving flagged authentication attempt failure data from the monitor model;
inputting the flagged authentication attempt failure data into a failure analysis model, wherein the failure analysis model is configured to classify the flagged authentication attempt failure data into classifications that indicate a reason the authentication attempt data failed;
receiving a classification for the authentication attempt data; and
determining a response based on the classification.
